(19) United States
(12) Patent Application Publication
(10) Pub. No.: US 2006/0075222 A1
(43) Pub. Date: Apr. 6, 2006

(54) System for personal group management based on subscriber certificates

(76) Inventors: Seamus Moloney, Riihimaki (FI); Pekka Laitinen, Helsinki (FI); Sampo Sovio, Vantaa (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(21) Appl. No.: 10/960,443

(22) Filed: Oct. 6, 2004

(51) Int. Cl. H04L 9/00

(52) U.S. Cl. 713/156; 713/173

(57) ABSTRACT

A method and corresponding equipment, for enabling a subscriber device (14) to engage a service provided by a server (12) to give a friend device (15) access to the service, including a step (21) in which the subscriber device (14) engages the server (12) to provide the service and obtains a subscriber certificate corresponding to the service; and a step (24) in which the subscriber device (14) issues to the friend device (15) a friend certificate based on the subscriber certificate, the friend certificate being such that it is recognized by the server as entitling the friend device to the service.

### TECHNICAL FIELD

The present invention pertains to the field of security in telecommunications using a public key infrastructure. More particularly, the present invention pertains to an extension of a conventional public key infrastructure.

### BACKGROUND ART

The invention is linked to the ongoing standardization activity at 3GPP (Third Generation Partnership Program) called Generic Authentic Architecture (GAA). GAA proposes to utilize the authentication infrastructure of cellular networks to enable authentication for a wide range of services. GAA aims to make it possible for cellular operators to issue certificates to their subscribers, and these certificates can then be used for authentication purposes.

Current mobile devices are typically capable of communicating over a number of different network bearers, including e.g. short-range bearers such as RFID (Radio Frequency Identifier) or infrared (line-of-sight) bearer, or of course a (long-range) cellular network. Short-range bearers can be used to achieve a secure transfer of data from one device to another, due to the short-range aspect of such communication. (For example, the sender and receiver are in view of each other and the communication is by line of sight, or only approximately good for not much more than the distance of separation of the sender and receiver.)

For secure communication over the Internet, the so-called Secure Socket Layer (SSL) protocol is used. The SSL protocol is a protocol layer that may be placed between a reliable connection-oriented network layer protocol (e.g. TCP/IP) and the application protocol layer (e.g. HTTP). SSL provides for secure communication between client and server by allowing mutual authentication, the use of digital signatures for integrity, and encryption for privacy.

Client certificates have typically been used by enterprises to control access to resources to known employees. So-called SSL tunnels—often called lightweight VPNs (Virtual Private Networks)—are enabled by using client certificates to achieve mutual authentication. Mutual authentication allows the client to authenticate the server and the server to authenticate the client.

Nokia Lifeblog is a new product designed to enable people to create a document on a mobile phone illustrating their lives in pictures, and to then place the document on the Internet, i.e. to upload the document. Many people would like to share such a document with only a selected group of people. To this end, first the document must not be accessible over the Internet to just anyone, and second, the document must be uploaded (from the mobile phone to the Internet) via a secure communication mechanism and when it is downloaded, the downloading communication ought also to be secure.

In many arrangements today, there is no access control of a web page to which mobile phones upload pictures or other data; the link to the web page thought is kept secret among the friends who want to share the information on the web page only among themselves. More complicated solutions may make use of usernames and passwords to achieve some level of privacy, but these are quite difficult to manage. For example, in case of using a password, revocation can be problematic.

What is needed is an intuitive means for delegating and managing access rights to such shared content.

### DISCLOSURE OF THE INVENTION

Accordingly, in a first aspect of the invention, a method is provided, comprising: a step in which a subscriber device engages a server to provide a service and obtains a subscriber certificate corresponding to the service; and a step in which the subscriber device issues to a friend device a friend certificate based on the subscriber certificate; wherein the friend certificate is recognized by the server as entitling the friend device to access the service.

In accord with the first aspect of the invention, the service may be to provide access to digital content stored on the server, or it may be to execute an application stored on the server.

Also in accord with the first aspect of the invention, the friend certificate may be created by the subscriber at least digitally signing the friend's public key. Also, it may indicate that it was issued by the subscriber device. Also still, the friend certificate may be a public key certificate binding a public key corresponding to a private key associated with the friend device and an identity indicating a user of the friend device or indicating the friend device, or it may be a so-called attribute certificate binding an identity indicating the friend device to one or more attributes in respect to a service.

In a second aspect of the invention, a computer program product is provided comprising a computer readable storage structure embodying computer program code thereon for execution by a computer processor, where the program code includes instructions for performing a method according to the first aspect of the invention.

In a third aspect of the invention, a device is provided, comprising: means by which the device engages a server to provide a service, and obtains from the server a subscriber certificate corresponding to the service; and means by which the device issues to a friend device a friend certificate based on the subscriber certificate; wherein the friend certificate is recognized by the server as entitling the friend device to access the service.

In a fourth aspect of the invention, a network server is provided, comprising: means, responsive to a request from a subscriber device for providing a service, and for providing the service upon presentation of an appropriate certificate; and means for issuing to the subscriber device a subscriber certificate corresponding to the service; wherein the appropriate certificate is a certificate issued by the subscriber device to a friend device.

In a fifth aspect of the invention, a system is provided, comprising: a server for hosting services; a subscriber device according to the third aspect of the invention and subscribed to a service hosted by the server; and a friend device including means for requesting and receiving a friend certificate from the subscriber device, and also means for presenting the friend certificate to the server in association with requesting access to the service.

### BRIEF DESCRIPTION OF THE DRAWINGS

The above and other objects, features and advantages of the invention will become apparent from a consideration of the subsequent detailed description presented in connection with accompanying drawings, in which:

FIG. 1 is a block diagram/flow diagram showing a storage server hosting digital content of a subscriber, and making the digital content available to a friend of the subscriber only upon presentation of a certificate provided to the friend according to the invention.

FIG. 1A is a block diagram of a subscriber device according to the invention.

FIG. 2 is a flow diagram of a process according to the invention and involving the entities shown in FIG. 1, a process in which the friend obtains access to the subscriber's digital content hosted by the storage server.

FIG. 3 is a schematic indicating a public key digital certificate and its use (according to the prior art).

### DETAILED DESCRIPTION OF THE INVENTION

The invention provides a secure means for cellular subscribers to share their digital content with their friends, for them to manage the set of friends allowed to see that content, and for operators to facilitate such sharing.

In using the invention, a cellular subscriber to a mobile network first generates a key pair in a mobile device. Then, using established (e.g. by 3GPP) procedures, the cellular subscriber obtains a certificate signed by the operator of the mobile network, and the mobile device then stores the certificate (in a data store in the mobile device). Next—in what is a first principal element of the invention—the cellular subscriber's mobile device functions as a delegated so-called Certifying Authority (CA), securely issuing certificates to peers it deems should be given access to the digital content (or even for receiving some other kind of service besides the downloading of digital content). Thus, according to the invention, a chain of trust is created between the operator CA root certificate, the subscriber certificate, and a friend/peer certificate. The chain can be verified at service usage, making it simple for the cellular subscribers to manage who is allowed access to the digital content. For the friends accessing the service, the resulting service usage takes place over a secure, mutually authenticated link, with minimal user interaction required. In what is a second principal element of the invention, a chain of trust is created between the delegated CA (the mobile phone in this exemplary description) and a server that authenticates subscriber certificates issued by the delegated CA, based on an existing 3GPP PKI (Public Key Infrastructure). The chain of trust is created by the server obtaining the operator's root key, using 3GPP GAA (Generic Authentication Architecture).

The invention builds on the idea of subscriber certificates being standardized in 3GPP. It also utilizes the fact that the majority of existing web servers have support for TLS/SSL client authentication. This is a little-used feature, which allows for strong authentication to web servers. In the existing Internet world, clients need to pay (for example 1000EUR) to root CAs in order to get a subscription certificate; paying is not a problem for servers but it is often a problem for ordinary PC users. According to a proposed 3GPP GAA, cellular subscribers can easily, securely and inexpensively obtain a subscribe certificate signed by their operator. In this invention we extend the idea of GAA, having a client act as an intermediate CA so that a server can trust certificates issued by the client.

Consider for example a network storage service—e.g. some disk space on the Internet that can be used for the storage of pictures or other digital content—provided by an operator on a storage server having an associated configuration file indicating directories of files as being owned by respective subscribers. When the mobile operator issues a subscriber certificate to a subscriber indicated in the configuration file as the owner of a directory, it updates the configuration file for the storage server. In the new configuration file, the directory owned by the subscriber is configured in such a way that all parties attempting to access the directory must present a certificate, signed by the owner of the directory. The subscriber could provide the content directly via the cellular network or indirectly via a PC and Internet connection.

In the invention, TLS/SSL Client authentication is preferably used to control access to the service. Thus, and as mentioned above, the subscriber owning the directory acts as an intermediate CA, allocating access rights to peers. The subscriber creates and maintains what is in effect an extension of the operator PKI. In acting as an intermediate CA, the subscriber receives the public key of a peer (a device) operated by a person known to them, probably using a local proximity bearer such as RFID or infrared or BlueTooth, or alternatively via a signalling channel (over e.g. a cellular communication channel).

According to the invention the subscriber could simply activate a menu item starting a waiting process for the arrival of the public key, and then when the key is received, a dialog box on the subscriber's display would request a name for the friend being certified. The subject name of the certificate could be something like: <Friend name>, “Friend of” <subscriber name>@<service name>. Thus, it would be clear what the subscriber certificate could be used for, and also who issued the certificate.

Thereafter, the subscriber would “sign” the friend's public key using the private key for which the subscriber would have the corresponding subscriber certificate (issued to Alice by the operator). A PIN (Personal Identification Number) code may be asked of Alice prior to the actual signing.

The signed key represents/serves as a “friend” certificate, which could be chained back to the mobile operator to enable authentication at operator sites, i.e. which is the end link of a chain of certificates leading back to the mobile operator CA. After the subscriber signs the friend's public key and so issues the friend certificate, the issued friend certificate is returned to the requesting device/friend over the same channel as was used to provide the friend's public key to the subscriber.

An alternative user experience could utilize SIP (Session Initiation Protocol) signalling. for example, a user—call her Alice—could advertise her encrypted files stored on a web server for members of some already existing group (e.g. a members of a hiking group/club). The advertisement could explain that in order to access the files a member of the group needs a certificate from Alice (acting as an intermediate CA). If a group member does not have a proper certificate from Alice, then a dialog box could ask, “Do you want to obtain a certificate from Alice in order to have access to the group files?” If the group member answers in the affirmative, then the public key stored in the device being used by the group member could be sent automatically to Alice via SIP, and after a couple of seconds, the group member could receive a certificate issued by Alice.

Now when the friend, using the mobile device that received the certificate, attempts to access the files/digital content of Alice on the storage server, the TLS/SSL client authentication occurs. The friend presents (ideally without any user interaction being required) the issued certificate to the storage server, and a secure tunnel is created between the friend's mobile device and the storage server so that the network storage server has authenticated the friend device and the friend device has authenticated the server. (Other people attempting to access the same site are not able to proceed past the authentication phase because they do not have a certificate.)

Ideally, a friend would not actually see a certificate; instead, there would be seamless protected access to the storage in question. (But the friend would still have to somehow convince Alice to tell the storage server it is all right to let the friend access the digital content of Alice on the storage server, and the friend would have to provide some reliable means of identification to the storage server to show that the friend is indeed who the friend claims to be.)

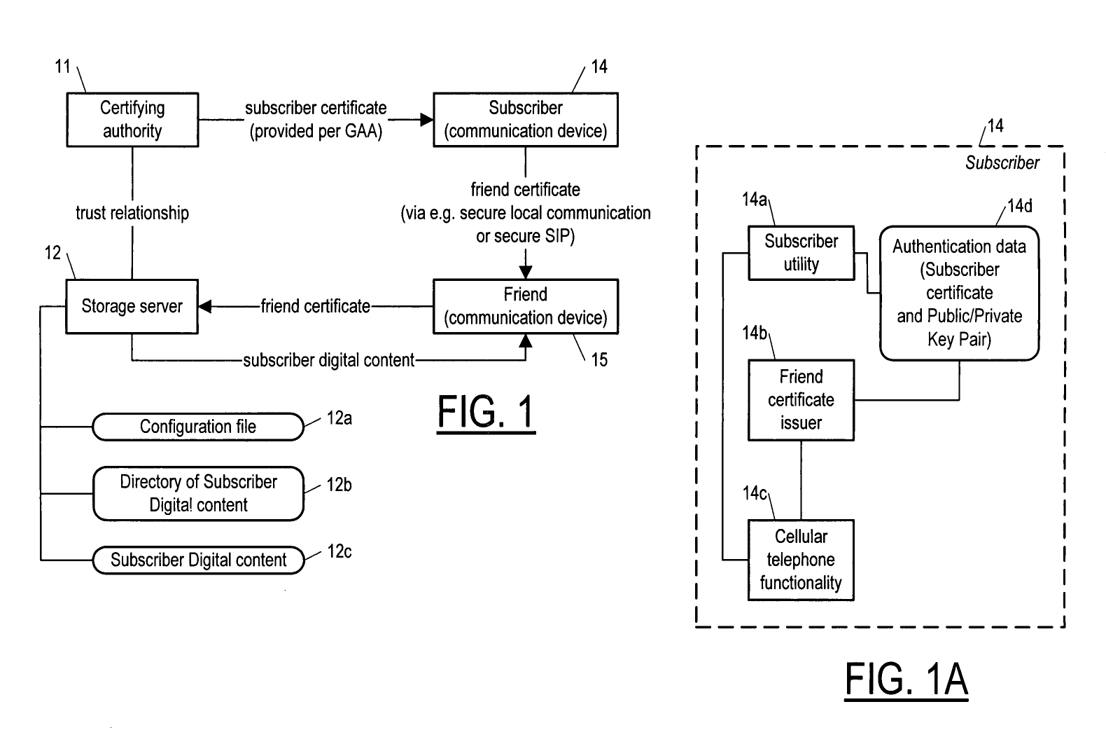

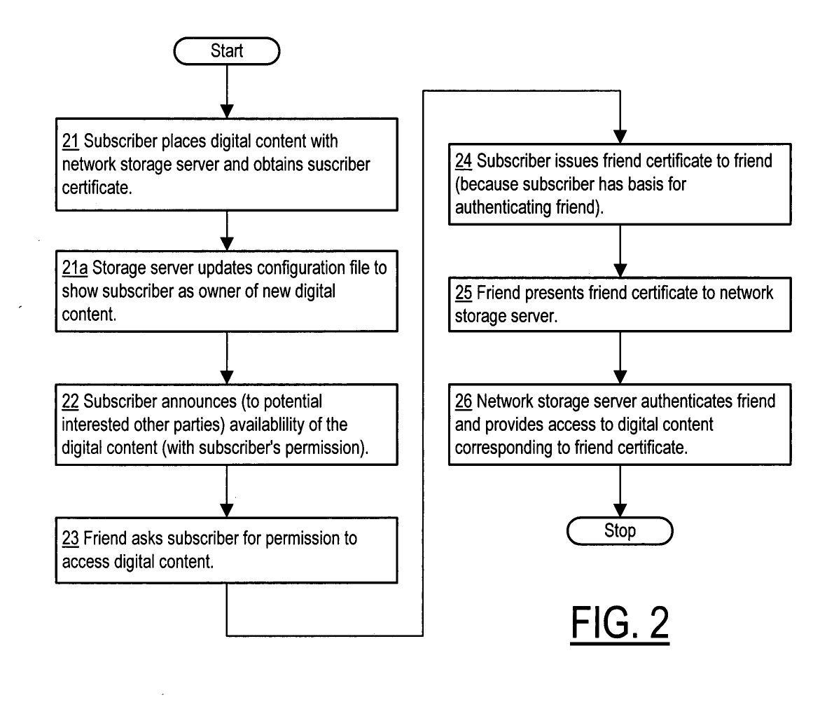

Thus, and referring now to FIGS. 1 and 2, according to the invention, in order to make it possible for a friend (communication device) 15 of a subscriber (communication device) 14 to access digital content 12c on a storage server 12, in a first step 21, the subscriber places digital content with the storage server and obtains a subscriber certificate from a CA 11 per GAA, i.e. the subscriber authenticates itself to the CA (and possibly vice versa) and the CA then issues the subscriber certificate. The CA may be e.g. the operator of a network providing the storage server 12 and so the associated network storage service. The storage server organizes digital content it hosts for various subscribers in a directory 12b of subscriber digital content, and indicates the owner of each directory in a configuration file 12a. Thus, in a next step 21a, the storage server updates the configuration file 12a to show the subscriber 14 as owner of the new digital content. In so updating the configuration file, the storage server marks the digital content so as to be accessible only upon presentation of a certificate signed by the subscriber/owner of the digital content. In a next step 22, the subscriber announces/advertises the availability of the digital content, indicating in the announcement that anyone interested in accessing the digital content must be authorized by the subscriber. To make the announcement (i.e. to advertise the availability), the subscriber could send an email or an SIP advertisement to members of a group of users who would be expected to want to access the digital content, or the subscriber could simply tell them in person. In a next step 23, the friend (communication device) asks the subscriber for permission to access the digital content. (As indicated above, the friend may, in some embodiments, first try to access the digital content, and the storage server 12 may then direct the friend to the subscriber.) In a next step 24, the subscriber issues a friend certificate to the friend, doing so because the subscriber has some basis for authenticating the friend. For example, the friend is nearby and so the subscriber knows that the request for the friend certificate is in fact coming from the friend. In a next step 25, the friend 15 presents the friend certificate to the network storage server along with a request for access to the digital content placed by the subscriber 14. In a next step 26, the storage server 12 authenticates the friend 15 (using e.g. TLS/SSL authentication) and provides access to the digital content corresponding to the friend certificate, i.e. to the digital content of the subscriber 14.

Referring now to FIG. 1A and also to FIG. 1, the subscriber device 14 is shown in case the subscriber is a cellular telephone device. The subscriber device also includes a subscriber utility module 14a for obtaining a subscriber certificate from the CA 11 and for storing the subscriber certificate in a store 14d of authentication data, where the subscriber's public/private key pair is also stored. The subscriber device also includes a friend certificate issuer 14b for issuing the friend certificate, as described above. The friend certificate issuer typically digitally signs any friend certificate being issued, and so obtains the subscriber's private key from the store 14d of authentication data, which it then uses in providing its digital signature to accompany the friend certificate. To provide cellular telephone functionality, the subscriber device includes a cellular telephone functionality module 14c, which includes at least a transceiver for radio communication with a radio access network of a cellular communication system. (The transceiver includes modules for coding voice or data for communication via the cellular communication system, and for modulating—possibly taking into account channel coding—a radio carrier using the encoded voice or data, according to specifications for the cellular communication system, and also modules for performing the inverse operations and error recovery.)

In some embodiments, the party (friend) receiving an authentication (friend) certificate could export the certificate and the private key to a personal computer and use it for accessing the protected web site. Most browsers support this functionality via the so-called PKCS#12 key packaging formats, the Personal Information Exchange Syntax Standard (developed and maintained by RSA Data Security, Inc.). (The syntax standard specifies a portable format for storing or transporting a user's private keys, certificates, and miscellaneous secrets.)

Also in some embodiments, the subscriber issuing access rights (e.g. Alice in the above example) could distribute the URL (Uniform Resource Locator) of the network storage along with the certificates. There could also be a centralized approach to the problem: a central storage, such as pictures.vodafone.com, could require TLS/SSL authentication and manage the mappings to the correct directories based on the submitted certificates.

Also in some embodiments, the mobile operator could keep track of all accesses to the site and be able to present the directory owner (the subscriber) with a list of peers that had recently accessed the named site. This could provide a means for the system to support so-called certificate revocation lists: a means to reject access from certain peers.

Also, and as already mentioned, the invention could be used in allocating access rights not only to storage services, but in respect to any service that would be willing to trust the mobile operator root certificates and the issuing procedures of the subscriber, and so would accept certificates delegated in the manner provided by the invention. Moreover, the invention is of use in peer-peer communication generally (not merely for communication via a cellular network), proximity communication (e.g. BlueTooth), and even in ad hoc communication. As an example of an ad hoc communication, assume that Alice (the subscriber) has a media server in a UPnP home network (i.e. a UPnP network implemented in Alice's home). In the UPnP home network, devices such as a personal media server, DVD player, or TV can communicate using WLAN (Wireless Local Area Network) or Bluetooth PAN (Personal Area Network). Assume that access is controlled for some of these devices, so that only friend devices authorized by Alice can use them. For example, only friend devices authorized by Alice can use the DVD player. More specifically, the DVD player could host Alice's public key stored as a root certificate in an access control list. When Bob visits Alice's at her home, she can issue a friend certificate to Bob by using infrared, SIP, or some other bearer/communication channel. More generally, if a group of people are in Alice's home, then she can issue friend certificate to each of the group members, one after the other.

Note that the invention does not require that uploading and downloading of the digital content be secure, only that the access to the digital content be secure. However, it is preferably for the uploading and downloading to also be secure. In such preferred embodiments, when a friend certificate is presented to the storage server, TLS client authentication occurs and a secure http connection is formed between the friend device and the network storage server. On the Internet, it is common practice to switch back to insecure HTTP after authentication (usually for performance reasons), and the invention allows such a switch back, but preferably, no such switching back is done.

The invention encompasses using two kinds of certificates for what are called “friend certificates” in the above description: a public key certificate or an attribute certificate. The public key certificate is used to tie a public key and an identity (i.e. for the certificate holder) together, i.e. to bind the two; and the attribute certificate is used tie one or more attributes to an identity in order to prove that the user indicated by the identity has indicated authorization or a role in respect to a service (or services) indicated in the certificate. For either kind of certificate, in the present invention the certificate is issued to the friend (Mary in the above) by the subscriber (Alice in the above) as a means of identifying the friend to the storage server as someone who is authorized (by the subscriber) to access the digital content.

In general, a public key certificate is a digitally signed document presented to others by the certificate holder to validate the holder's authorization (to e.g. access digital content) and identity. The document consists of a specially formatted block of data that contains the name of the certificate holder (which may be either a user or a system name) and the holder's public key, as well as the digital signature of a certification authority for authentication. The certification authority attests that the sender's identity is the identity associated with the public key in the document. A user ID packet, containing the certificate holder's unique identifier (sometimes called a “distinguished name”), is sent after the certificate packet.

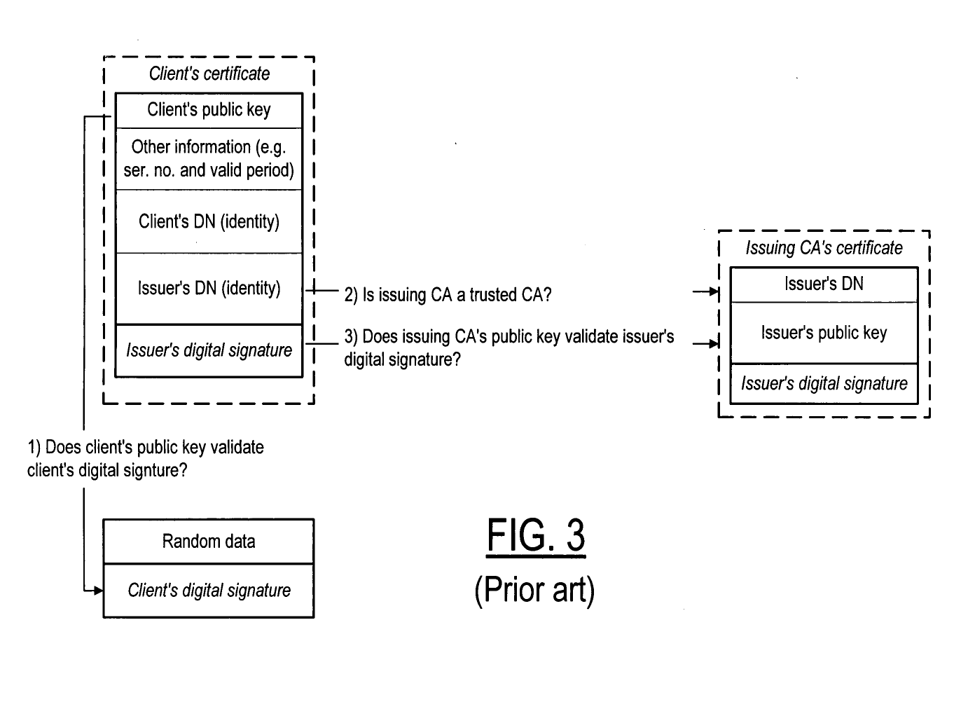

In a typical SSL client authentication, and now referring to FIG. 3, the client presents to a server the client's public key digital certificate issued by a certifying authority trusted by the server, and the client's digital certificate typically includes at least: the client's public key and client's identity/distinguished name, along with the certifying authority's identity/distinguished name, all digitally signed by the certifying authority. In addition, the client provides a document containing random data, digitally signed by the client. The server then typically does at least the following: First, it checks that the client's public key (which can be got from the digital certificate without decrypting) validates the client's digital signature (of the random data). Next, it determines the CA from the digital certificate (again without any decrypting), and if the CA is trusted by the server, obtains the CA's public key (which it may have locally, or may have to access from another site). Finally, it validates the client's digital certificate using the CA's public key.

If the server does not trust the issuer of the certificate, then the client must present a chain of certificates leading to a CA that server does trust. The chain must ordinarily be traversed from the root certificate (issued by trusted CA) to the leaf certificate (certificate corresponding to link farthest from the root certificate) because only the public key for the root certificate (trusted CA) is available to the server, and the root certificate provide the public key to be used for the next link, and so on.

In case of using the present invention, the subscriber may wish to allow friends access to the subscriber's digital content even without the friend having a public key certificate, and so the digital certificate issued by the subscriber to the friend according to the invention need only indicate the identity/distinguished name of the friend, and not also vouch for a public key.

More specifically, in case of a public key certificate embodiment of the invention in which the friend has a public key, the invention enables the following scenario in which Mary (friend) wants access to Alice's (subscriber) digital content on a server. After Alice has uploaded the digital content to the server and configured the server to allow access to the content only to those users that have a public key certificate signed by Alice, Alice issues Mary a PK type friend certificate, with Alice digitally signing the certificate, and with the certificate indicating that Alice is the issuer. (In other than a public key certificate embodiment, the certificate need not provide a public key for Mary, nor even indicate the identity of Mary.) To access the digital content, Mary then presents to the server (as a step in the TLS handshake with the server) the digital certificate issued by Alice. (Only the digital certificate issued by Alice to Mary is given to the server during the TLS handshake. Alice's certificate is needed in order to validate the certificate chain, but a TLS handshake allows only one certificate to be delivered from the client to the server. The server must get hold of Alice's certificate by some other means, such as from the CA's directory server, from which Alice's certificate can be fetched using the “subject DN (distinguished name)” of Alice's certificate as the key.) The server then validates the digital certificate issued to Mary using standard chaining techniques, and so authenticating each link of a chain leading from the CA to Mary. (In case of embodiments in which Mary does not have a public key, or at least in case even if Mary does have a public key, it is not included in the digital certificate issued to Mary, all that need be checked is that first, Alice did in fact digitally sign the certificate issued to Mary, and second, that Alice is who she says she is, which is checked via the digital certificate issued by the CA to Alice.) Since the server is configured to allow access to the digital content of Alice to anyone presenting a certificate signed by Alice, the server allows Mary to access the digital content of Alice.

Now in case of an attribute certificate embodiment, first Alice uploads the digital content to the server and configures the server to allow access to that content to only those users that have an attribute certificate signed by Alice and specifying that they have access to the digital content. Next, Alice issues Mary an attribute certificate (as the friend certificate in this embodiment) giving Mary access to the digital content. In this case the friend certificate contains Mary's PK identity (the identity bound to a public key per a digital certificate issued by the CA to Mary), but does not include Mary's public key (or the public key of anyone else). Next, Mary initiates TLS with the server using Mary's digital certificate issued by the CA. (Only Mary's digital certificate issued by the CA is given to the server during the TLS handshake.) The server then validates Mary's digital certificate as usual. Next, Mary tries to access Alice's digital content on the server through the TLS tunnel. The server then requests an attribute certificate from Mary. Mary, in response, presents the attribute certificate issued to Mary by Alice. The server then checks that: the attribute certificate is indeed signed by Alice, that it contains the identity for Mary bound to the public key in the digital certificate issued to Mary by the CA, and that it indicates that Mary is indeed authorized by Alice to access the digital content of Alice. The server then grants access to Mary.

Note that, as explained above, Alice needs to be able to authenticate the certification request coming from Mary, regardless of the embodiment. Such authentication can be done in several ways. One way is based on proximity, using BT, IrDA, or some local (short-range) channel, i.e. so that Mary and Alice are more or less face-to-face when Mary makes the request. Another way can be based on an existing trust relationship between Mary and Alice implemented using: a login/password shared beforehand between Alice and Mary; Mary uses a certificate of her own issued by the operator; or Alice explicitly trusts the channel over which the certification request comes, as e.g. in case of communication via SIP signaling.

Note also that the ISP/network operator would preferably have configured the server hosting the digital content of Alice, rather than Alice having to perform any server configuring so as to restrict access to the digital content of Alice.

It is to be understood that the above-described arrangements are only illustrative of the application of the principles of the present invention. Numerous modifications and alternative arrangements may be devised by those skilled in the art without departing from the scope of the present invention, and the appended claims are intended to cover such modifications and arrangements.

What is claimed is:

1. A method, comprising:
a step in which a subscriber device engages a server to provide a service and obtains a subscriber certificate corresponding to the service; and
a step in which the subscriber device issues to a friend device a friend certificate based on the subscriber certificate;
wherein the friend certificate is recognized by the server as entitling the friend device to access the service.

2. A method as in claim 1, wherein the service is to provide access to digital content stored on the server.

3. A method as in claim 1, wherein the service is to execute an application stored on the server.

4. A method as in claim 1, wherein the friend certificate is created by the subscriber at least digitally signing the friend's public key.

5. A method as in claim 1, wherein the friend certificate indicates that it was issued by the subscriber device.

6. A method as in claim 1, wherein the friend certificate is a public key certificate binding a public key corresponding to a private key associated with the friend device and an identity indicating a user of the friend device or indicating the friend device.

7. A method as in claim 1, wherein the friend certificate is an attribute certificate binding an identity indicating the friend device to one or more attributes in respect to a service.

8. A computer program product comprising a computer readable storage structure embodying computer program code thereon for execution by a computer processor, wherein said computer program code comprises instructions for performing a method including: the steps of claim 1.

9. A device, comprising:
means by which the device engages a server to provide a service, and obtains from the server a subscriber certificate corresponding to the service; and
means by which the device issues to a friend device a friend certificate based on the subscriber certificate;
wherein the friend certificate is recognized by the server as entitling the friend device to access the service.

10. A device as in claim 9, wherein the service is to provide access to digital content stored on the server.

11. A device as in claim 9, wherein the service is to execute an application stored on the server.

12. A device as in claim 9, wherein the device creates the friend certificate by at least digitally signing the friend's public key.

13. A device as in claim 9, wherein in creating the friend certificate, the device indicates in the friend certificate that it the device is the issuer of the friend certificate.

14. A device as in claim 9, wherein the friend certificate is a public key certificate binding a public key corresponding to a private key associated with the friend device and an identity indicating a user of the friend device or indicating the friend device.

15. A device as in claim 9, wherein the friend certificate is an attribute certificate binding an identity indicating the friend device to one or more attributes in respect to a service.

16. A network server, comprising:
means, responsive to a request from a subscriber device for providing a service, and for providing the service upon presentation of an appropriate certificate; and
means for issuing to the subscriber device a subscriber certificate corresponding to the service;
wherein the appropriate certificate is a certificate issued by the subscriber device to a friend device.

17. A system, comprising:
a server, for hosting services;
a subscriber device including:
means by which the subscriber device engages the server to provide a service and obtains a subscriber certificate corresponding to the service; and
means by which the subscriber device issues to a friend device a friend certificate based on the subscriber certificate;
wherein the friend certificate is recognized by the server as entitling the friend device to access the service;
and the system further comprising:
a friend device, including means for requesting and receiving the friend certificate from the subscriber device, and also means for presenting the friend certificate to the server in association with requesting access to the service.
